(19) United States
(12) Patent Application Publication
(10) Pub. No.: US 2010/0244318 A1
(43) Pub. Date: Sep. 30, 2010

(54) INSERT MOLDING METHOD AND DEVICE

(75) Inventors: Masatoshi KOBAYASHI, Hagagun (JP); Shunichi Yorozuya, Hagagun (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/724,020

(22) Filed: Mar. 15, 2010

(30) Foreign Application Priority Data
Mar. 31, 2009 (JP) 2009-84848

(51) Int. Cl. B29C 45/14

(52) U.S. Cl. 264/279; 425/517

(57) ABSTRACT

An insert molding method and device that does not require secondary injection of molten resin uses a metallic mold which forms a cavity 5 between a front cavity 3 and a rear cavity 4, and is provided with a process of retaining an inserted object 2 inside the cavity 5 by a retaining pin 8, a process of flowing a molten resin inside the cavity 5, a process of detecting a positional relationship between a flow front of the molten resin and the retaining pin 8, and a process of retreating the retaining pin 8 when it is detected that the flow front is at a predetermined position. The device is provided with the front cavity 3, the rear cavity 4, the retaining pin 8, a retaining pin controlling means 10, and a flow front position detecting means 11.

### BACKGROUND OF THE INVENTION

1. Field of the Invention

The present invention relates to an insert molding method and an insert molding device.

2. Description of the Related Art

Conventionally, for example according to Japanese Patent No. 3, 962, 295, there is known a method of forming an electronic substrate sealed with a resin by an insert injection molding.

In the insert injection molding method mentioned above, a metallic mold which forms a cavity between a front cavity and a rear cavity is used, and the electronic substrate as an inserted object is retained by retaining pins, that are provided so as to freely advance into and retreat from the cavity. After primarily injecting a molten resin into the cavity, a resin-sealed electronic substrate as an insert molded article is obtained, by retreating the retaining pins from the cavity.

However, by doing so, resin-lacking spaces (pin traces) are generated in the insert molded article, at the traces after the retaining pins are retreated from the cavity, so that there is an inconvenience that the pin traces must be filled by secondarily injecting the molten resin into those spaces.

### SUMMARY OF THE INVENTION

In view of such circumstances, an object of the present invention is to provide an insert molding method and device which do not require secondary injection of the molten resin.

In order to achieve the above object, the present invention provides an insert molding method comprising: a process of retaining, in a metallic mold which forms a cavity between a front cavity and a rear cavity, an inserted object to a predetermined position in the cavity, by advancing into the cavity a retaining pin provided so as to freely advance into and retreat from the cavity; a process of making a molten resin flow inside the cavity, in the state where the inserted object is retained by the retaining pin; a process of detecting a positional relationship between a flow front of the molten resin within the cavity and the retaining pin; and a process of retreating the retaining pin from within the cavity, when it is detected that the flow front is at the position within a predetermined range with respect to the retaining pin.

According to the insert molding method of the present invention, first, the inserted object is arranged at the predetermined position inside the cavity formed between the front cavity and the rear cavity. Here, the inserted object arranged inside the cavity is retained by making the retaining pins provided so as to freely advance into and retreat from the cavity to advance into the cavity.

Next, the molten resin is made to flow inside the cavity. As a method of making the molten resin flow, for example, a method of making the resin flow by injecting the molten resin into the cavity from outside the metallic mold in the state where the metallic mold is closed, a method of making the resin flow by pressurizing the molten resin by closing the metallic mold in the state where the molten resin is preliminarily arranged inside the cavity, may be given.

Next, the positional relationship between the flow front of the molten resin flowing inside the cavity and the retaining pin is detected. The detection of the positional relationship between the flow front of the molten resin and the retaining pin may be carried out by providing, for example, sensors such as a pressure sensor or a temperature sensor. The sensor may be provided at a position facing the cavity at an upstream side of the flow of the molten resin by a predetermined distance from the position where the retaining pin retains the inserted object, or may be buried inside the metallic mold as long as it is capable of detecting the flow front of the molten resin.

Thereafter, when it is detected by the sensor that the flow front of the molten resin has reached the position within a predetermined range with respect to the retaining pin, the retaining pin is retreated from inside the cavity. As a result, the flowing molten resin is filled into the portion where the retaining pin had been positioned, so that it is possible to prevent occurrence of a space without resin (pin trace) formed at the trace where the retaining pin is retreated from the cavity, in the obtained insert molded article. Therefore, according to the insert molding method of the present invention, it becomes possible to make the secondary injection of the molten resin unnecessary.

Moreover, when a plurality of the retaining pins are provided, the sensors in a same number thereto may be provided in a corresponding manner to each retaining pin, or one sensor may be provided in a corresponding manner to the retaining pin positioned at a most upstream side in a flowing direction of the molten resin.

When only one sensor is provided to a plurality of the retaining pins, for example, a flow speed of the molten resin is calculated from the volume of the molten resin flowing inside the cavity and the capacity of the cavity. Then, when it is detected by the sensor that the flow front of the molten resin has reached the position within a predetermined range from the retaining pin at the most upstream side of the flow of the molten resin, the retaining pins may be sequentially retreated along the flow from the one positioned at the most upstream side of the flow of the molten resin, on the basis of the calculated flow speed of the molten resin.

The insert molding method of the present invention may be implemented advantageously by an insert molding device equipped with a metallic mold which forms a cavity between a front cavity and a rear cavity, and a retaining pin provided so as to freely advance into and retreat from the cavity for retaining an inserted object to a predetermined position of the cavity by advancing into the cavity, comprising; a flow front position detecting means which is provided so as to be capable of detecting a positional relationship between a flow front of a molten resin flowing inside the cavity and the retaining pin; and an advance/retreat controlling means which controls advancing and retreating of the retaining pin into and from the cavity, and which retreats the retaining pin from within the cavity, when it is detected by the flow front position detecting means that the flow front is at a position within a predetermined range with respect to the retaining pin.

### BRIEF DESCRIPTION OF THE DRAWINGS

FIG. 1 is an explanatory cross-sectional view showing a configuration of an insert molding device according to a first embodiment;

FIG. 2 is an explanatory cross-sectional view showing a first operation of the insert molding device according to the first embodiment;

FIG. 3 is an explanatory cross-sectional view showing a second operation of the insert molding device according to the first embodiment;

FIG. 4 is an explanatory cross-sectional view showing a third operation of the insert molding device according to the first embodiment;

FIG. 5 is an explanatory cross-sectional view showing a variation of the insert molding device according to the first embodiment;

FIG. 6 is an explanatory cross-sectional view showing a configuration of an insert molding device according to a second embodiment;

FIG. 7 is an explanatory cross-sectional view showing a first operation of the insert molding device according to the second embodiment;

FIG. 8 is an explanatory cross-sectional view showing a second operation of the insert molding device according to the second embodiment; and

FIG. 9 is an explanatory cross-sectional view showing a third operation of the insert molding device according to the second embodiment.

### DETAILED DESCRIPTION OF THE PREFERRED EMBODIMENTS

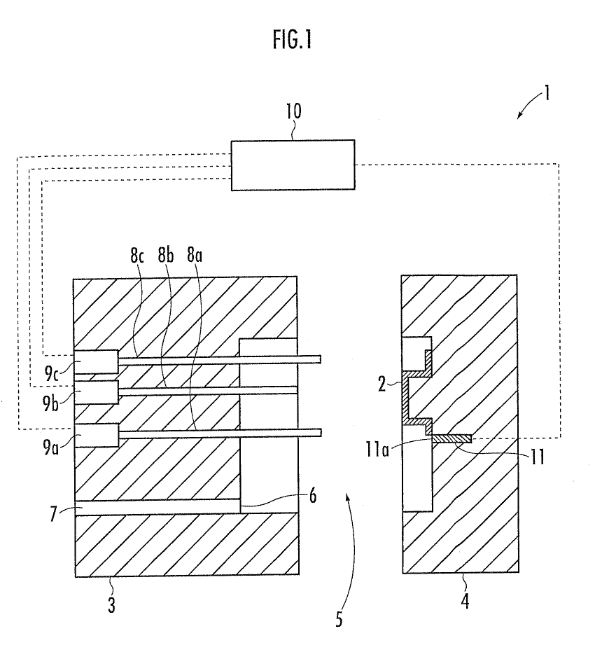

A configuration of an insert molding device 1 according to a first embodiment of the present invention will be now described in detail with reference to FIG. 1.

As shown in FIG. 1, the insert molding device 1 of the present embodiment is for injection molding an insert molded article equipped with an inserted object 2, and is comprised of a metallic mold equipped with a front cavity 3 and a rear cavity 4. Between the front cavity 3 and the rear cavity 4, there is formed a cavity 5 of a shape conforming to an external shape of the molded article.

The front cavity 3 is provided with a runner 7 which communicates with the cavity 5 via a gate 6 provided at the lower part of the cavity 5. The runner 7 communicates with a molten resin injection nozzle not shown. Further, the front cavity 3 is equipped with retaining pins 8a, 8b, and 8c that are provided so as to freely advance into and retreat from the cavity 5. Here, the retaining pin 8a is provided closest to the gate 6, the retaining pin 8c is provided farthest from the gate 6, and the retaining pin 8b is provided at the intermediate position between the retaining pins 8a and 8c.

The insert molding device 1 is equipped with retaining pin driving units 9a, 9b, and 9c for advancing and retreating the retaining pins 8a, 8b, and 8c into and from the cavity 5. The retaining pin driving units 9a, 9b, and 9c are electrically connected to a retaining pin controlling means 10. As the retaining pin driving units 9a, 9b, and 9c, for example, a servomotor or a hydraulic motor (not shown) may be used. The retaining pin controlling means 10 is equipped with, for example, a CPU, a RAM, a ROM or the like, and controls advancing and retreating of the retaining pins 8a, 8b, and 8c into and from the cavity 5.

The rear cavity 4 is equipped with a pressure sensor 11 at a wall departing from the wall coming into contact with the retaining pin 8a by a predetermined distance towards the gate 6 side. The pressure sensor 11 is provided so as to expose a sensor portion 11a at a position facing the cavity 5. The pressure sensor 11 operates as a flow front position detecting means which detects a flow front of molten resin R. The pressure sensor 11 is electrically connected to the retaining pin controlling means 10.

Next, an injection molding method of the present embodiment using the insert molding device 1 will be explained below with reference to FIG. 1 through FIG. 4.

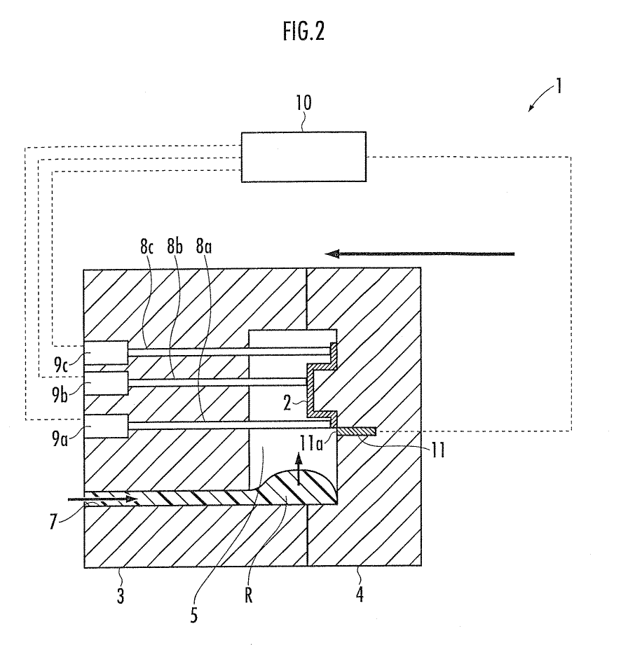

First, as is shown in FIG. 1, the inserted object 2 is arranged at the rear cavity 4 at a part of a surface forming the cavity 5. Next, the rear cavity 4 is moved towards the front cavity 3 so as to close the metallic mold. Thereafter, as is shown in FIG. 2, the retaining pin controlling means 10 controls the retaining pin driving units 9a, 9b, and 9c and make the corresponding retaining pins 8a, 8b, and 8c advance into the cavity 5, so as to retain the inserted object 2 between the retaining pins 8a, 8b, and 8c and the wall surface of the rear cavity 4.

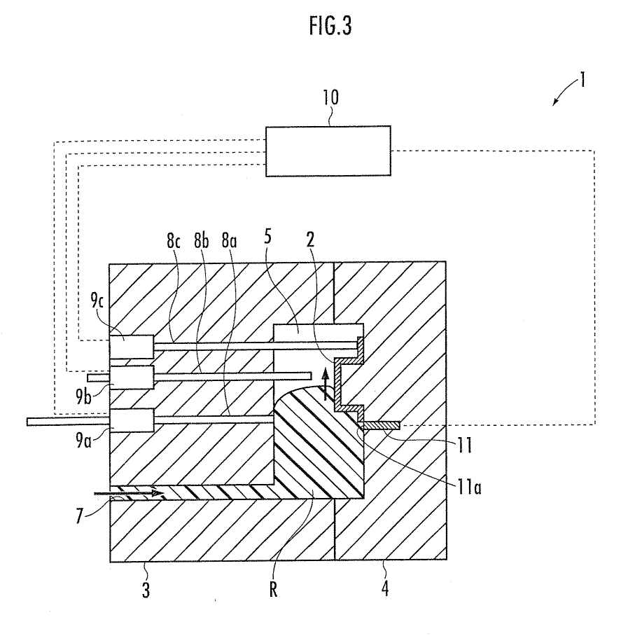

Next, as is shown in FIG. 3, the molten resin R is injected into the cavity 5 from the molten resin injection nozzle via the runner 7 and the gate 6. The molten resin R injected into the cavity 5 flows from the lower side of the cavity 5 to the upper side thereof. When the flow front of the molten resin R reaches the position of the sensor portion 11a of the pressure sensor 11, the pressure sensor 11 transmits the detection signal thereof to the retaining pin controlling means 10.

When the retaining pin controlling means 10 receives the detection signal, as is shown in FIG. 3, the retaining pin controlling means 10 first retreats the retaining pin 8a from inside of the cavity 5 to the surface of the front cavity 3. Next, the retaining pin controlling means 10 calculates the time until the flow front of the molten resin R reaches a predetermined distance from each of the retaining pins 8b and 8c, from the volume of the molten resin R injected into the cavity 5 and the capacity of the cavity 5. Thereafter, the retaining pin controlling means 10 sequentially retreats the retaining pin 8b and 8c from inside the cavity, when the current time reaches each of the calculated time.

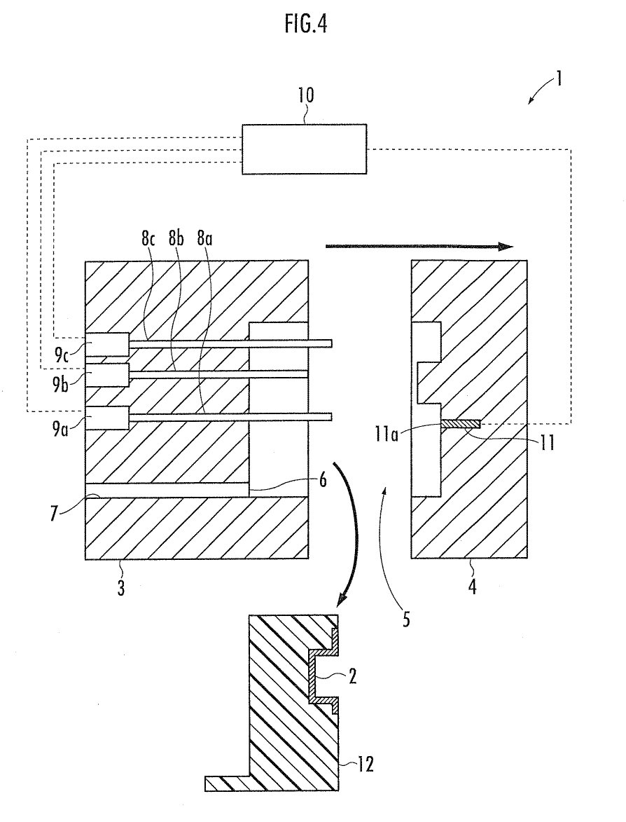

After the cavity 5 is filled with the molten resin R, and the molten resin R is cooled and solidified, an insert molded article 12 is demolded and taken out from the metallic mold, by opening the rear cavity 4 and the front cavity 3, as is shown in FIG. 4.

As is explained above, in the insert molding device 1, when the flow front of the molten resin R is detected by the pressure sensor 11, the retaining pin controlling means 10 controls respective retaining pins 8a, 8b, and 8c to which the distance to the flow front reached the predetermined distance range to sequentially retreat into the front cavity 3. By doing so, traces of the retaining pins 8a, 8b, and 8c, which retained the inserted object 2, are filled with the molten resin R, so that it is possible to obtain the insert molded article 12 without resin-lacking spaces (without pin traces). Therefore, according to the injection molding method of the present embodiment, it becomes possible to eliminate the need for a secondary injection of the molten resin R.

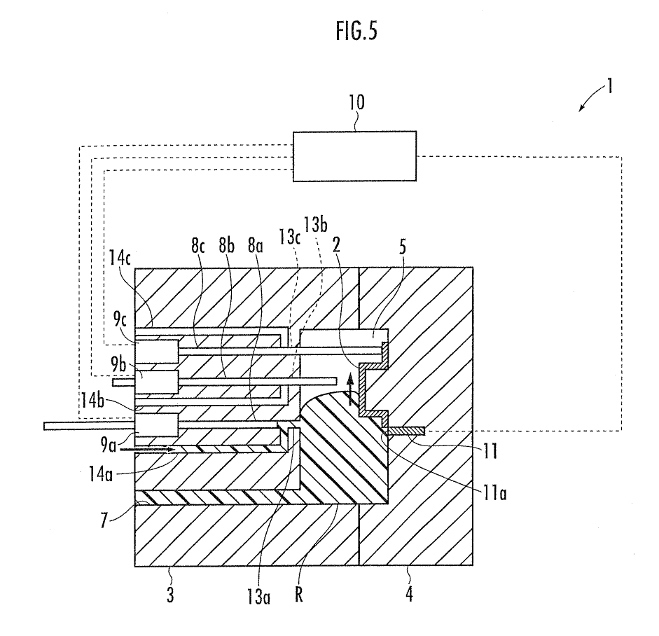

When trying to obtain a comparatively large inserted molded article 12 in the insert molding device 1 of the first embodiment, pin holes 13a, 13b, and 13c within which the retaining pins 8a, 8b, and 8c move may be provided so as to communicate with runners 14a, 14b, and 14c, as is shown in FIG. 5. When taking the configuration mentioned above, after retreating the retaining pins 8a, 8b, and 8c into the cavity 5, the retaining pins 8a, 8b, and 8c are sequentially retreated further, so as to position the same to be rearward from the connecting position of the pin holes 13a, 13b, and 13c and the runners 14a, 14b, and 14c, respectively. By doing so, it becomes possible to inject the additional molten resin R into the cavity 5 via the pin holes 13a, 13b, and 13c, by using the pin holes 13a, 13b, and 13c as multipoint gates. In this case, each of the retaining pins 8a, 8b, and 8c operate as gate opening/closing pins.

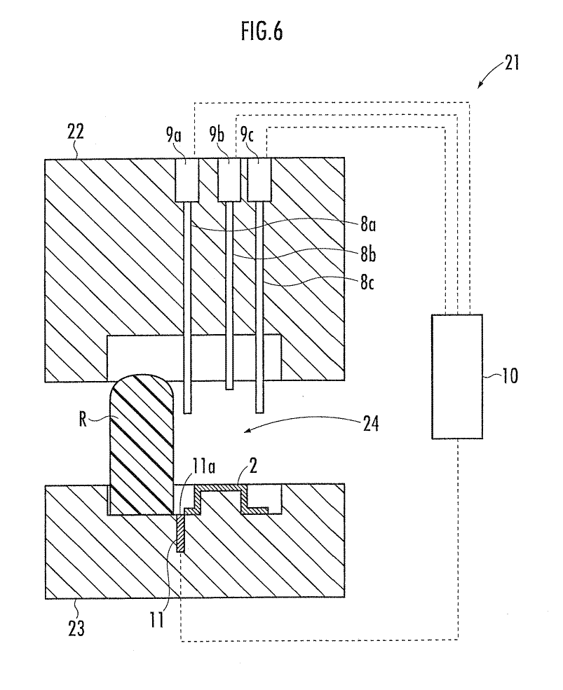

Next, an insert molding device 21 of a second embodiment of the present invention will be explained with reference to FIG. 6 through FIG. 9.

First, with reference to FIG. 6, the configuration of the insert molding device 21 of the present embodiment will be explained. The insert molding device 21 is used to obtain a comparatively thick-walled and rigid insert molded article, by press molding the insert molded article equipped with the inserted object 2.

In order to perform press molding mentioned above, as is shown in FIG. 6, the insert molding device 21 of the present embodiment is comprised of a vertical type metallic mold equipped with a mold 22 and a mold 23. In the insert molding device 21, the mold 22 provided on the upper side is the front cavity, and the mold 23 provided on the lower side is the rear cavity. Between the mold 22 and the mold 23, there is formed a cavity 24 of a shape conforming to an external shape of the molded article. Here, the insert molding device 21 may be configured so that the mold 22 provided on the upper side is the rear cavity, and the mold 23 provided on the lower side is the front cavity.

The insert molding device 21 performs press molding by placing the pre-heated and melted resin R in the cavity 24, closing the mold 22 and mold 23, pressurizing the resin R and making the resin R flow.

The mold 22 is equipped with the retaining pins 8a, 8b, and 8c, and the retaining pin driving units 9a, 9b, and 9c, and the retaining pin driving units 9a, 9b, and 9c are electrically connected to the retaining pin controlling means 10. As the retaining pin driving units 9a, 9b, and 9c, for example, a servomotor (not shown) may be used. The retaining pin controlling means 10 is equipped with, for example, a CPU, a RAM, a ROM and the like, and controls advancing and retreating of the retaining pins 8a, 8b, and 8c into and from the cavity 24.

The mold 23 is equipped with the pressure sensor 11 at a wall departing from the wall coming into contact with the retaining pin 8a by a predetermined distance in the upstream side of the flow of the resin R. The pressure sensor 11 is provided so as to expose the sensor portion 11a at a position facing the cavity 24. The pressure sensor 11 operates as the flow front position detecting means which detects the flow front of the resin R flowing inside the cavity 24. The pressure sensor 11 is electrically connected to the retaining pin controlling means 10.

Next, a press molding method of the present embodiment using the insert molding device 21 will be explained below with reference to FIG. 6 through FIG. 9.

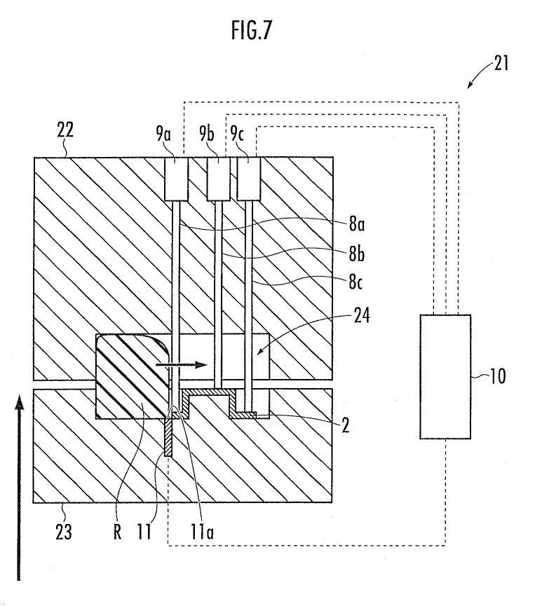

First, as is shown in FIG. 6, the inserted object 2 is arranged at the mold 23 at a predetermined position forming the cavity 24. Next, the preliminarily heated and melted resin R of a volume sufficient for filling the cavity 24 is arranged in the mold 23 at a portion forming the cavity 24. Then, the mold 23 is moved towards the mold 22 so as to close the metallic mold. Thereafter, as is shown in FIG. 7, the retaining pin controlling means 10 controls the retaining pin driving units 9a, 9b, and 9c and make the corresponding retaining pins 8a, 8b, and 8c advance into the cavity 24, so as to retain the inserted object 2 between the retaining pins 8a, 8b, and 8c and the wall surface of the mold 23. Here, the retaining pin 8a is provided closest to the gate 6, the retaining pin 8c is provided farthest from the gate 6, and the retaining pin 8b is provided at the intermediate position between the retaining pins 8a and 8c.

Here, in the insert molding device 21, the resin R is pressurized and made to flow inside the cavity 24, by closing the mold 22 and the mold 23. Thereafter, when the flow front of the resin R reaches the position of the sensor portion 11a of the pressure sensor 11, the pressure sensor 11 transmits the detection signal thereof to the retaining pin controlling means 10.

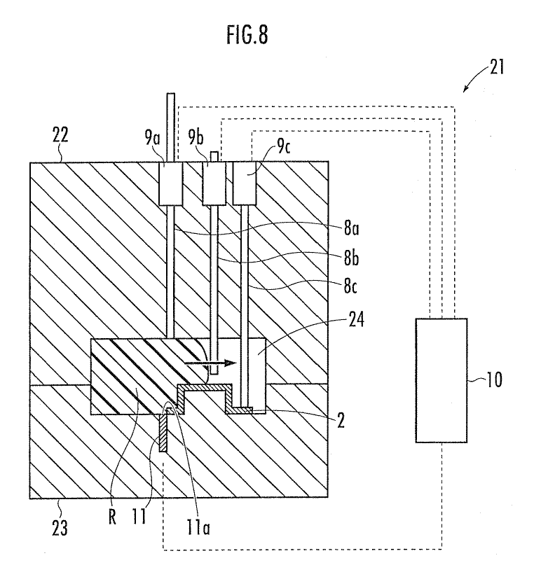

When the retaining pin controlling means 10 receives the detection signal, as is shown in FIG. 8, the retaining pin controlling means 10 first retreats the retaining pin 8a from the inside of the cavity 24 to the surface of the mold 22. Next, the retaining pin controlling means 10 calculates the time until the flow front of the melted resin R reaches a predetermined distance from each of the retaining pins 8b and 8c, from the volume of the resin R melted inside the cavity 24 and the capacity of the cavity 24. Thereafter, the retaining pin controlling means 10 sequentially retreats the retaining pins 8b and 8c from inside the cavity 24, when the current time reaches the calculated time.

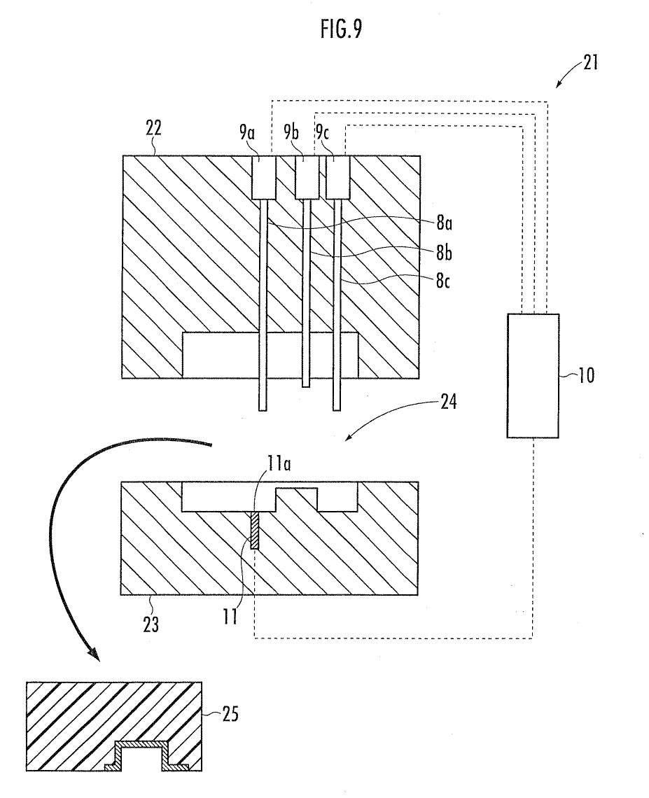

After the melted resin R is filled all over the cavity 24, the insert molding device 21 holds the resin R at a pressurized state. Thereafter, when the resin R is cooled and solidified, an insert molded article 25 is demolded and taken out from the metallic mold, by opening the mold 23 and the mold 22, as is shown in FIG. 9.

As is explained above, when the flow front of the melted resin R is detected by the pressure sensor 11, the retaining pin controlling means 10 controls respective retaining pins 8a, 8b, and 8c to which the distance to the flow front reached the predetermined distance to sequentially retreat into the mold 22. By doing so, traces of the retaining pins 8a, 8b, and 8c, which retained the inserted object 2, are filled with the melted resin R, so that it is possible to obtain the insert molded article 25 without resin-lacking spaces (without pin traces). Therefore, according to the injection molding method of the present embodiment, it becomes possible to eliminate the need for the resin that is secondarily filled to the pin traces during the post treatment.

According to the insert molding device 21 of the present embodiment, the resin R preliminarily heated and melted is arranged inside the cavity 24, and the resin R is pressurized and made to flow, by closing the mold 22 and the mold 23. However, in place thereof, the mold 22 and the mold 23 may be provided with a metallic mold heating means, and the solid resin R arranged inside the cavity 24 may be made to flow by heating and melting the solid resin R with the metallic mold heating means.

In the insert molding devices 1 and 21 of the respective embodiments, three retaining pins 8 are provided. However, the present invention is not limited thereto, and the retaining pins 8 may be in any number as long as it is capable of appropriately retaining the inserted object 2.

Further, in the insert molding devices 1 and 21 of the respective embodiments, one pressure sensor 11 is provided as the flow front position detecting means. However, the present invention is not limited thereto, and the pressure sensor 11 may be provided one each to the position in the vicinity of each retaining pins 8a, 8b, and 8c. Still further, the flow front position detecting means may be other sensor, such as a temperature sensor.

What is claimed is:

1. An insert molding method, comprising:
a process of retaining, in a metallic mold which forms a cavity between a front cavity and a rear cavity, an inserted object to a predetermined position in the cavity, by advancing into the cavity a retaining pin provided so as to freely advance into and retreat from the cavity;
a process of making a molten resin flow inside the cavity, in the state where the inserted object is retained by the retaining pin;
a process of detecting a positional relationship between a flow front of the molten resin within the cavity and the retaining pin; and
a process of retreating the retaining pin from within the cavity, when it is detected that the flow front is at the position within a predetermined range with respect to the retaining pin.

2. The insert molding method according to claim 1,
wherein the retaining pin is advanced into and retreated from the cavity by a hydraulic motor.

3. The insert molding method according to claim 1,
wherein the retaining pin is advanced into and retreated from the cavity by a servomotor.

4. The insert molding method according to claim 1,
wherein the positional relationship between the flow front of the molten resin within the cavity and the retaining pin is detected by a pressure sensor.

5. The insert molding method according to claim 1,
wherein the positional relationship between the flow front of the molten resin within the cavity and the retaining pin is detected by a temperature sensor.

6. The insert molding method according to claim 1,
wherein the metallic mold includes a plurality of the retaining pins provided so as to freely advance into and retreat from the cavity,
the method further comprises a process of calculating, when it is detected that the flow front is at the position within a predetermined range with respect to the retaining pin positioned at a most upstream side in a flowing direction of the molten resin, time until the flow front of the molten resin reaches a predetermined distance with respect to each retaining pin, from the volume of the molten resin within the cavity and the capacity of the cavity, and
a process of sequentially retreating from the cavity the retaining pin to which the flow front of the molten resin reached the predetermined distance, each time the time reaches each calculated time.

7. The insert molding method according to claim 1,
wherein the metallic mold includes a plurality of the retaining pins provided so as to freely advance into and retreat from the cavity, and
the positional relationship between the flow front of the molten resin within the cavity and the retaining pin is detected for each retaining pin, and the retaining pins are retracted from the cavity sequentially from the retaining pin which is detected that the flow front is at the predetermined position within a predetermined range.

8. An insert molding device equipped with a metallic mold which forms a cavity between a front cavity and a rear cavity, and a retaining pin provided so as to freely advance into and retreat from the cavity for retaining an inserted object to a predetermined position of the cavity by advancing into the cavity, comprising;
a flow front position detecting means which is provided so as to be capable of detecting a positional relationship between a flow front of a molten resin flowing inside the cavity and the retaining pin; and
an advance/retreat controlling means which controls advancing and retreating of the retaining pin into and from the cavity, and which retreats the retaining pin from within the cavity, when it is detected by the flow front position detecting means that the flow front is at a position within a predetermined range with respect to the retaining pin.

9. The insert molding device according to claim 8,
wherein the device comprises a hydraulic motor which advances and retreats the retaining pin into and from the cavity.

10. The insert molding device according to claim 8,
wherein the device comprises a servomotor which advances and retreats the retaining pin into and from the cavity.

11. The insert molding device according to claim 8,
wherein the flow front position detecting means is a pressure sensor.

12. The insert molding device according to claim 8,
wherein the flow front position detecting means is a temperature sensor.

13. The insert molding device according to claim 8,
wherein the device comprises a plurality of the retaining pins provided so as to freely advance into and retreat from the cavity, and
the flow front position detecting means is provided at the wall of the metallic mold at an upstream side than the retaining pin positioned at a most upstream side in a flowing direction of the molten resin inside the cavity, and
the advance/retreat controlling means calculates, when it is detected by the flow front position detecting means that the flow front is at the position within a predetermined range with respect to the retaining pin positioned at a most upstream side in the flowing direction of the molten resin, time until the flow front of the molten resin reaches a predetermined distance with respect to each retaining pin, from the volume of the molten resin within the cavity and the capacity of the cavity, and sequentially retreats from the cavity the retaining pin to which the flow front of the molten resin reached the predetermined distance, each time the time reaches each calculated time.

14. The insert molding device according to claim 8,
wherein the device comprises a plurality of the retaining pins provided so as to freely advance into and retreat from the cavity, and
a plurality of the flow front position detecting means provided in a corresponding manner to each retaining pin at a wall of the metallic mold on an upstream side than each retaining pin in the flowing direction of the molten resin,
and wherein the advance/retreat controlling means sequentially retreats from the cavity the retaining pin which is detected by the flow front position detecting means that the flow front of the molten resin is at the predetermined position.
